(19) United States
(12) Patent Application Publication
(10) Pub. No.: US 2026/0019495 A1
(43) Pub. Date: Jan. 15, 2026

(54) METHOD TO MITIGATE PHONE THEFT

(71) Applicant: MOTOROLA MOBILITY LLC, WILMINGTON, DE (US)

(72) Inventor: RANJEET GUPTA, AURORA, IL (US)

(21) Appl. No.: 18/773,465

(22) Filed: Jul. 15, 2024

(51) Int. Cl. H04M 1/72463; H04M 1/72421

(52) U.S. Cl. CPC H04M 1/724631; H04M 1/72421

(57) ABSTRACT

A method of mitigating the theft of a portable electronic device communicatively connected to a second portable electronic device via a communications subsystem comprising a short range wireless network. Upon detecting that predetermined theft mitigation criteria have been met activating threat mitigation measures including at least locking the screen of the potentially stolen device and prompting the potentially stolen device to emit an alarm tone to alert bystanders.

### BACKGROUND

### 1. Technical Field

The present disclosure generally relates to portable electronic devices that wirelessly connected with other portable devices, and more specifically to mitigating theft of electronic devices that are wirelessly interconnected over a local network.

### 2. Description of the Related Art

Portable electronic devices, including smart devices such as wearables and smart phones, integrate a number of capabilities to improve their utility, and thus, their appeal. Smart phones allow users to communicate wirelessly with others, to perform online tasks and activities, such as managing social media accounts, playing virtual reality games, and checking work and personal emails, and to otherwise connect with and curate the user's real and virtual lives. Wearable devices complement smart phones, especially in so far as they allow for the real-time monitoring and long-term tracking of health and exercise data associated with the wearer. Often paired together over a local area network, many users find the combination of a wearable portable electronic device and a non-wearable portable electronic device indispensable in their daily lives.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to mitigate the theft of the device or of another connected second device, according to one or more embodiments;

FIG. 2 depicts an example component makeup of an example second electronic device with specific components that enable the second electronic device to mitigate the theft of a connected first device, according to one or more embodiments;

FIGS. 3A-3C depict schematic views illustrating different configurations whereby a first and a second electronic device work in concert to mitigate the theft of either one of the devices, according to multiple embodiments;

FIG. 4 depicts a schematic view illustrating a communication system environment within which interconnected first and second electronic devices operate to mitigate the theft of one of the electronic devices, according to one or more embodiments;

FIG. 5 depicts example user interfaces of the electronic devices shown in FIG. 4, according to several embodiments;

FIG. 6 depicts a flowchart diagram illustrating a method for mitigating the theft of an electronic device, according to one or more embodiments; and

FIG. 7 depicts a flowchart illustrating a second method for mitigating the theft of an electronic device, according to one or more embodiments.

### DETAILED DESCRIPTION

According to aspects of the present disclosure, an electronic device, a method, and a computer program product provide techniques for mitigating the theft of a portable electronic device that is communicatively connected to a second electronic device. Two or more portable electronic devices may be linked directly or over a network via short-range wireless technologies (e.g. Bluetooth®, Wi-Fi, NearLink, near field communication (NFC), or low power wide area network (LPAN)). Note that the terms short-range and near-field (separate from NFC) are used interchangeably. Both terms refer to a limited range over which devices may be connected directly or via a localized wireless connection. A device such as a smart watch may connect to a mobile phone over a Bluetooth® Low Energy (BLE) connection established manually by a user. The connection between the two devices can alternatively be established via a Wi-Fi link if both devices are connected to the same gateway network, e.g., when Bluetooth® connection is not available. Once connected to each other, the devices are trusted by each other, granting the person operating one device access to potentially sensitive information such as passwords and financial information saved on the other device. This makes theft or loss of connected portable electronic devices a top concern of users.

Because of the portability of the devices and the high value of these devices, the devices are susceptible to being stolen, e.g., if left unattended, accessible in a pocket, or targeted by a nefarious individual seeking to take the device. Often, the user does not discover or realize that the electronic device has been stolen/taken until long after the thief/nefarious individual has left the area from which the device was stolen/taken.

In one or more embodiments, upon noticing one of his paired devices is missing, a user may manually depress a button on the remaining device, which causes the transmission of a control signal to the missing device, prompting the missing device to implement mitigation measures. According to one or more embodiments, the mitigation measures can include the control signal rendering the missing device unusable and/or activating a tracking feature to track the missing device, and potentially lead to recovery of the missing device. In other embodiments, theft mitigation may be prompted automatically when the distance between paired portable electronic devices exceeds a set threshold. For example, if the distance between the devices exceeds a first threshold range but is less than (i.e., within) the effective range of the short-range wireless network, theft mitigation protocol is automatically activated on the remaining device and autonomously or remotely triggered on the potentially stolen device via issuance of a control signal over the short-range connection. Additionally, in one or more embodiments, if the distance between the devices exceeds the effective range of the short-range wireless network or the short-range wireless connection between the devices is broken prematurely without the user's action, the remaining device can transmit a control signal via the cellular network or another external network to the missing device, prompting the start of theft mitigation measures at the missing device. Accordingly, disclosed embodiments can provide significant benefits to users in early detection and mitigation of instances of potential theft of their portable electronic devices or other types of unwanted/unapproved removal from the user's possession.

The disclosed embodiments alleviate the aforementioned issues that can occur when portable electronic devices are misplaced, lost, stolen or otherwise taken without the user's permission. By monitoring the location of paired devices and taking corrective action if one of the paired devices moves beyond a pre-established distance threshold from the other device (which is itself not being moved away from an initial location and/or is relatively stationary) or determined to be missing, users can better protect and/or recover the devices.

An electronic device configured to mitigate theft of a connected portable electronic device is disclosed. The device includes a display embedded in a user accessible surface of the electronic device. The device includes a communications subsystem comprising an interface that enables the electronic device to communicatively connect via a wireless connection to a second electronic device. The device includes a memory having stored thereon a theft mitigation module (TMM) for controlling a plurality of hardware elements of the electronic device. The device includes at least one processor communicatively coupled to the display, the communications subsystem, and the memory, the at least one processor executing program code of the theft mitigation module. The at least one processor is configured to cause the electronic device, in response to one or more preset triggering criteria being met, activate theft mitigation measures comprising transmitting at least one control signal that triggers the second electronic device to perform at least one of: locking a second device screen, and emitting an alarm tone. In one or more embodiments, the transmitted instructions can be transmitted concurrently within a single control signal configured with one of a trigger command or a series of trigger commands to effect a particular one of the theft mitigation measures at the second device. In one or more alternate embodiments, the transmitted instructions can be transmitted concurrently within a single control signal having a single trigger that causes the second device to perform a plurality of different theft mitigation measures. In yet another embodiment, separate control signals can be transmitted in sequence (or at different times) to effect specific ones of the theft mitigation measures depending on a particular context in which the devices are operating, such as relative location or separation distance.

In some embodiments, the wireless connection is achieved using at least one short-range wireless connection from a group that includes: Bluetooth®, Wi-Fi, or near field communication. In some embodiments, the one or more preset triggering criteria are associated with a potential theft of the second device, and to perform the mitigation measures, the at least one processor is further configured to cause the electronic device to generate and transmit a notification to a law enforcement reporting system to report the potential theft of the second electronic device to authorities. In some embodiments, the preset triggering criteria comprise manual depression of an actuator (physical button) of the electronic device. In other embodiments, the preset triggering criteria comprises manual depression of a selectable icon (or other presented virtual selection affordance, such as a slide bar or check box) within a graphical user interface presented on the screen of the display. In some embodiments, to perform the theft mitigation measures, the at least one processor is further configured to cause the electronic device to transmit instructions via a wireless communication network connection to trigger the second electronic device to record and (periodically) transmit its global positioning system (GPS) location, network location, and barometric data to at least one of the electronic device, third electronic devices, and cloud storage accessible to the second electronic device. In some embodiments, the at least one processor is further configured to cause the electronic device to perform at least one of (1) generate and automatically upload information related to a potential theft of the second electronic device to previously designated social media accounts that are directly accessible via the second electronic device, and/or (2) disable second electronic device access to said previously designated social media accounts that are directly accessible via the second electronic device. In one or more embodiments, the latter disabling can be via a control signal sent to the second electronic device which performs the disabling locally, such as removing password access or disabling/locking the apps on the second electronic device from direct access. In some embodiments, the at least one processor is further configured to cause the electronic device to determine whether a distance between the electronic device and the second electronic device has exceeded a first pre-established threshold distance that is still within an effective range of the short-range wireless connection. The at least one processor is then further configured to cause the electronic device to, in response to the distance between the electronic device and the second electronic device exceeding the first pre-established threshold distance, generate and transmit, via the short-range wireless connection, a signal that prompts the second electronic device to implement preprogrammed theft mitigation measures. In some embodiments, the at least one processor is further configured to cause the electronic device to determine whether a distance between the electronic device and the second electronic device has exceeded a second pre-established threshold distance that is at or outside the effective range of the short-range wireless connection. The at least one processor is further configured to cause the electronic device to, in response to the distance between the electronic device and the second electronic device exceeding the second pre-established threshold distance, generate and transmit, over a cellular wireless communication network, a control signal that prompts the second electronic device to implement preprogrammed theft mitigation measures and implement GPS tracking of the device.

A method for mitigating theft of a portable electronic device is disclosed. The method includes detecting, by a processor of an electronic device that is communicatively connected via a short-range wireless connection to a second electronic device, a trigger condition corresponding to a potential theft of the connected second electronic device. The method incudes, in response to detecting the trigger condition, activating theft mitigation measures. The theft mitigation measures in response to one or more preset triggering criteria being met, activate theft mitigation measures comprising transmitting at least one control signal that triggers the second electronic device to perform at least one of: locking a second device screen, and emitting an alarm tone.

A computer program product comprising a non-transitory computer readable medium operative to mitigate the theft of a portable electronic device is disclosed. The computer program product has program instructions that when executed by a processor of an electronic device that comprises an interface that enables the electronic device to communicatively connect via a wireless connection to a second electronic device, configure the electronic device to perform the above presented and other method functions.

The above descriptions contain simplifications, generalizations and omissions of detail and are not intended as a comprehensive description of the claimed subject matter but, rather, are intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices, are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

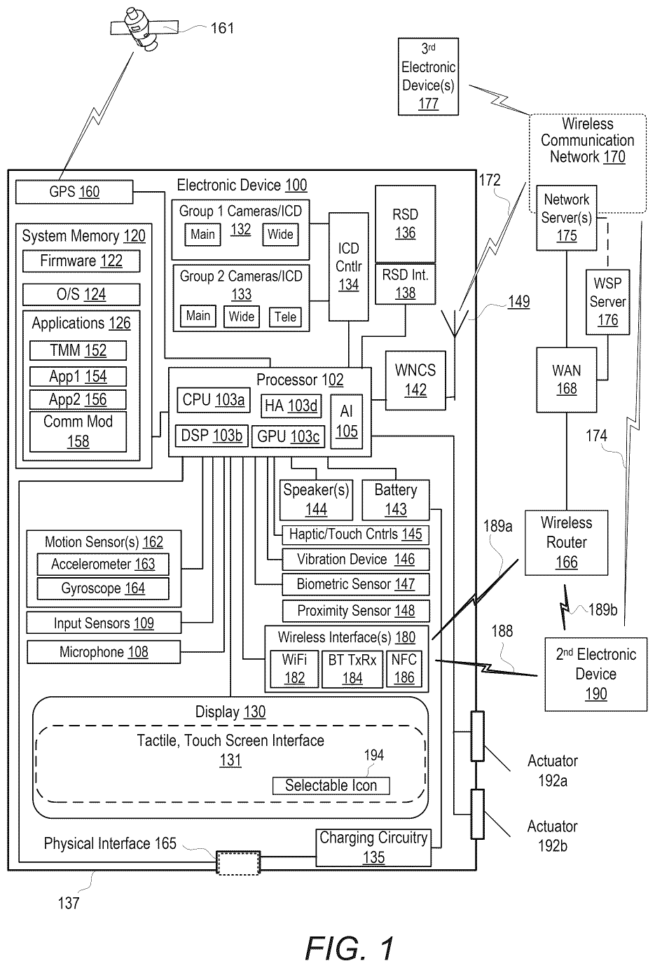

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

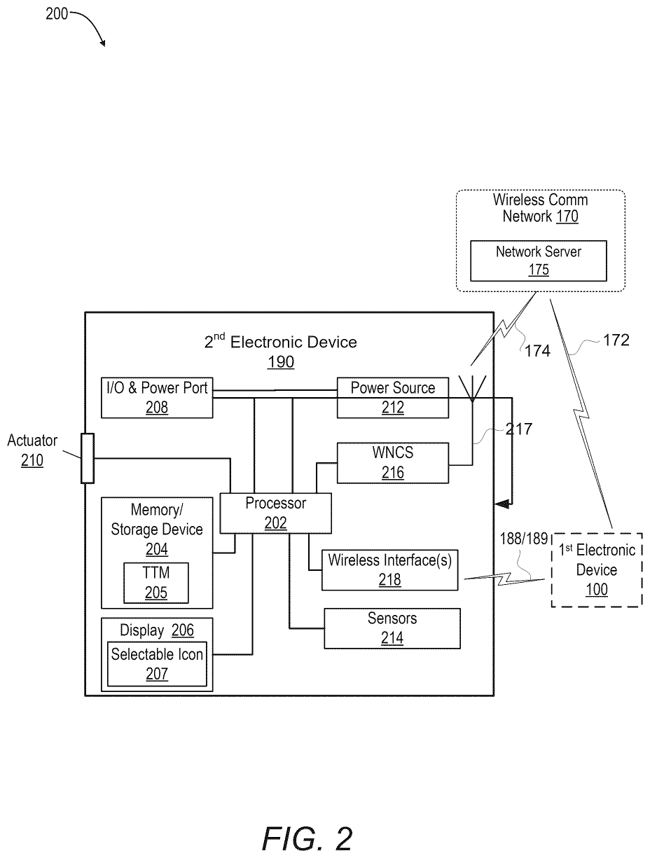

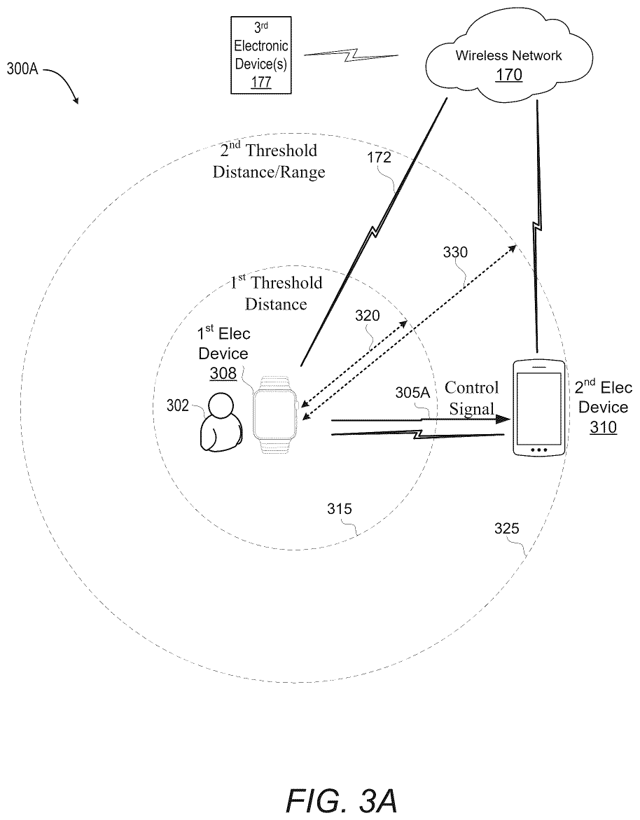

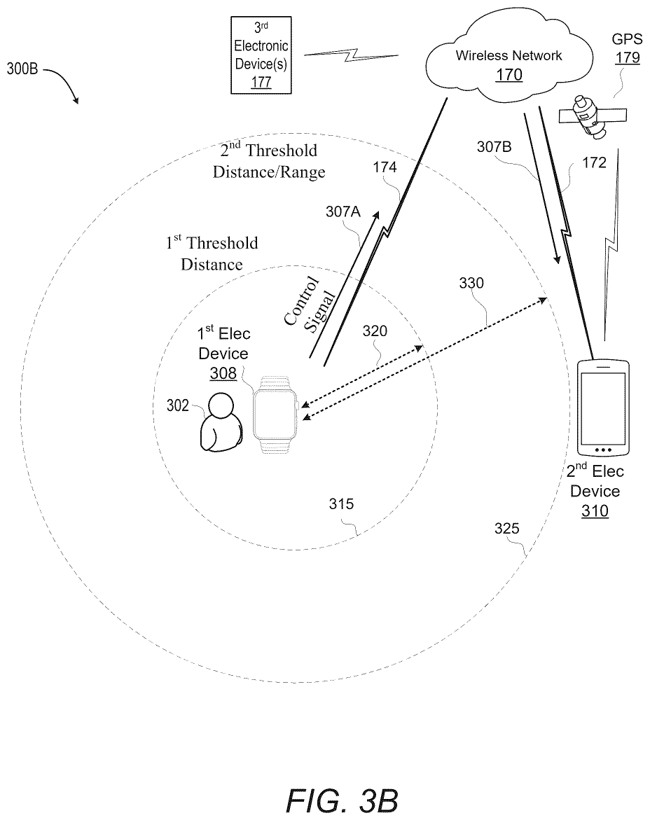

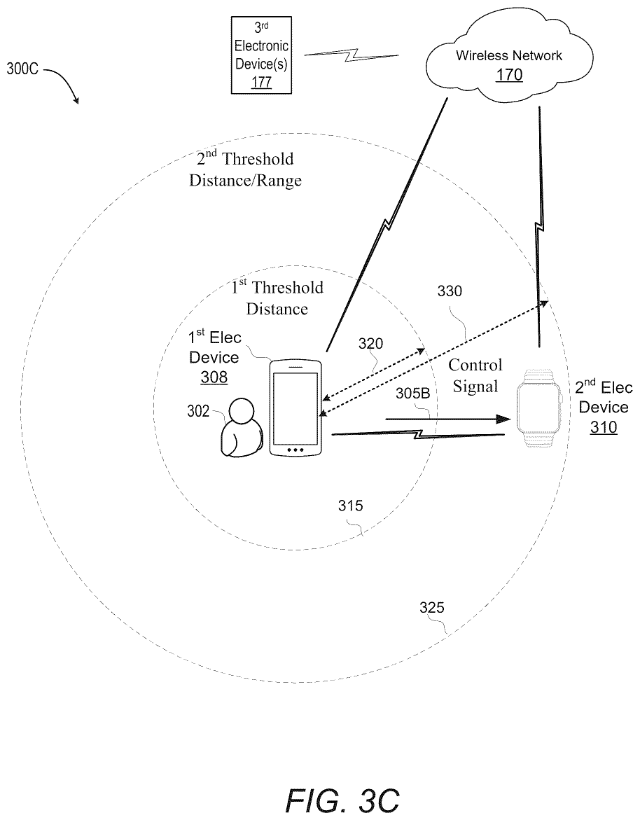

Referring now to the figures and beginning with FIG. 1, there is illustrated an example component makeup of electronic device 100, within which various aspects of the disclosure can be implemented, according to one or more embodiments. Electronic device 100 includes specific components that enable the device to provide mitigation of the theft of an electronic device. Examples of electronic device 100 include, but are not limited to, mobile devices, a notebook computer, a laptop, a mobile phone, a smart phone, a digital camera with enhanced processing capabilities, a smart watch, a tablet computer, and other types of electronic device. In the described embodiments, reference is made to a first electronic device and a second electronic device. For purposes of the description of the various embodiments herein, and as illustrated by FIG. 3A, FIG. 1 is presented as/from the perspective of the second electronic device, which is the device that has been stolen or physically taken and is moving away from the user. FIG. 2 is presented as the first electronic device, which is a wearable portable electronic device. However, it is appreciated that, as illustrated by FIG. 3C, the specific references to first electronic device and second electronic device are interchangeable, such that the second electronic device that is stolen or being taken away is the wearable smart watch of FIG. 2, and the features of the first electronic device are provided by the electronic device (e.g., mobile phone or laptop) of FIG. 1.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to system memory 120, input devices (introduced below), output devices, including integrated display 130, and image capture device (ICD) controller 134.

For simplicity in describing the features of the electronic device 100, the functionality provided by one or more of CPU 103a, DSP 103b, GPU 103c, and ICD controller 134 are collectively described as being performed by processor 102 (or controller 102). Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, theft mitigation module (TMM) 152, other applications, indicated as App1 154 and App2 156, and communication module 158. Each module and/or application provides program instructions/code that are processed by processor 102 to cause/configure processor 102 and/or other components of electronic device 100 to perform specific operations, as described herein. Descriptive names assigned to these modules add no functionality and are provided solely to better identify the underlying features performed by processing the different modules. For example, TMM 152 can include program instructions for implementing theft mitigation features of disclosed embodiments.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes integrated display 130 which incorporates a tactile, touch screen interface 131 that can receive user tactile/touch input. As a touch screen device, integrated display 130 with tactile, touch screen interface 131 can be utilized as an input device that allows a user to provide input to or to control electronic device 100 by touching features within the user interface presented on display 130. Touch screen interface 131 can include one or more virtual buttons or other selectable icons, indicated generally as 194. In one or more embodiments, when a user applies a finger on touch screen interface 131 in the region demarked by virtual button 194, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108 and one or more input buttons or actuators, indicated as 192a and 192b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 192a and 192b (or actuators) may provide controls for volume, power, and ICDs 132, 133. Additionally, electronic device 100 can include input sensors 109 (e.g., sensors enabling gesture detection by a user and sensors detecting proximity of a user or person).

Electronic device 100 also includes one or more output devices such as speakers 144. Electronic device 100 further includes haptic touch controls 145, vibration device 146, fingerprint/biometric sensor 147, proximity sensor 148, global positioning system (GPS) module/interface 160, and motion sensor(s) 162. Vibration device 146 can cause electronic device 100 to vibrate or shake when activated. Vibration device 146 can be activated during an incoming call or message in order to provide an alert or notification to a user of electronic device 100. In one or more embodiments, vibration device 146 can be autonomously activated by processor 102 in response to (or in the event of) detecting a communicatively-connected second electronic device moving away from electronic device (performing the functions of a first electronic device) beyond a first threshold distance in order to provide an alert or notification to a user of electronic device 100 of potential theft of the second electronic device. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, an ICD can be utilized as a biometric sensor for facial recognition, and biometric sensor 147 can be used in addition to an ICD (camera) for user detection/identification and verification.

GPS module/interface 160 can provide time data and location data about the physical location of electronic device 100 using geospatial input received from GPS satellites 161. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y, and Z). Gyroscope 164 measures rotation or angular rotational velocity of electronic device 100. Electronic device 100 further includes a housing 137 (generally represented by the thick exterior rectangle) that contains/protects the components internal to electronic device 100. In one or more embodiments, motions sensors 162 can provide feedback that serves as a trigger for the electronic device 100 to report movement away from second electronic device 190 at a rate of speed that may correlate to another person absconding or moving away with electronic device 190.

Electronic device 100 also includes a physical interface 165. Physical interface 165 of electronic device 100 can serve as a data port and can also be used as a power supply port that is coupled to charging circuitry 135 and device battery 143 to enable recharging of device battery 143 and/or powering of device.

Electronic device 100 further includes wireless network communication subsystem (WNCS) 142, which can represent one or more front end devices (not shown) that are each coupled to one or more antennas 148. In one or more embodiments, WNCS 142 can include one or more baseband processors or digital signal processors, one or more modems, and a radio frequency (RF) front end having one or more transmitters and one or more receivers. Example communication module 158 within system memory 120 enables electronic device 100 to communicate with wireless communication network 170 and with other devices, such as network server 175, wireless service provider (WSP) server 176, and other connected devices, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WNCS 142 and antennas 148 allow electronic device 100 to communicate wirelessly with internal components/devices of wireless communication network 170 via transmissions of communication signals to and from network communication devices, such as base stations or cellular nodes, of wireless communication network 170. Wireless communication network 170 further allows electronic device 100 to wirelessly communicate with network server 175, and other communication devices, such as third electronic devices 177, which can be similarly connected to wireless communication network 170 or indirectly connected via a wide area network (WAN) 168, such as the Internet. In one or more embodiments, various functions that are being performed on electronic device 100 can be supported using or completed via/on WSP server 176. In one or more embodiments, WSP server 176 can store images, such as captured screenshots, and/or metadata pertaining to captured screenshots. WSP server 176 can also store current location data of/from electronic device 100.

While shown as directly connected to the wireless network 170, 3^{rd} electronic devices 177 (e.g., devices owned by acquaintances of the user of the missing device) may be made accessible to the first device 100, the second device 190 or the wireless communication network 170 through any suitable datalink. Notably, as one mitigation measure, the missing device, e.g., electronic device 100, may be triggered by the remaining device (190) to transmit the GPS location of the missing device (100) to one or more predetermined electronic devices (e.g. 3^{rd} electronic devices 177) registered to acquaintances of a user of the second device (100).

Electronic device 100 can also wirelessly communicate, via short-range wireless interface(s) 180, with second electronic device 190 and/or wireless communication network 170 via communication signals 188, 189 transmitted by short-range communication device(s) (generally 180). Wireless interface(s) 180 can include transceivers, and/or a short-range wireless communication adapters, including wireless fidelity (Wi-Fi) transceivers 182 for Wi-Fi connectivity, Bluetooth transceiver 184, and near field communication (NFC) transceiver 186. In one or more embodiments, electronic device 100 can receive Internet or Wi-Fi based calls, text messages, multimedia messages, and other notifications via wireless interface(s) 180. In one or more embodiments, electronic device 100 can communicate wirelessly with external wireless devices, such as a WiFi router 166 or second electronic device 190, via wireless interface(s) 180. In one or more embodiments, electronic device 100 can be communicatively connected to/with a connected second electronic device 190, which can be user wearable device, via direct connection with one of the external wireless interfaces 180 (e.g., BT) or indirectly via a local network, such as provided by WiFi router 166. In one example embodiment, connected second device 190 can have or be configured with a Bluetooth adapter to enable Bluetooth connectivity with electronic device 100. In one or more embodiments, WNCS 142 with antenna(s) 148 and wireless interface(s) 180 collectively provide wireless communications subsystem of electronic device 100.

Electronic device 100 of FIG. 1 is only a specific example of a device that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device.

In one or more embodiments, TMM 152 includes program instructions that are processed by processor 102 which is configured to cause electronic device 100 to detect a trigger condition corresponding to the potential theft of one of two electronic devices connected via short range wireless connection. Trigger conditions can include determining (e.g. via proximity sensors 148) the distance between the two electronic devices 100, 190 and assessing that the distance exceeds one or more threshold distances. An example first threshold distance is a distance that is close enough to allow for a continued direct short range wireless connection between the two devices but beyond a point designated by the user as the furthest distance the user would be from the potentially stolen device under normal conditions. An example second threshold distance is a distance beyond which direct short range wireless communication between the two devices is not supported or possible (i.e., beyond the range of the wireless signal connecting the two devices). Assuming the theft is of connected second electronic device 190, with electronic device 100 being the remaining device, upon detecting that the first threshold has been exceeded, processor 102 is configured to cause the remaining electronic device (i.e., first electronic device 100) to send a control message directly over short range wireless connection 188 to the missing electronic device (i.e., second electronic device 190), prompting the missing device to perform theft mitigation measures. Alternatively, upon detecting that the second threshold has been exceeded, processor 102 is configured to cause the remaining electronic device to send control message(s) via the wireless communication network 170 to the missing electronic device, prompting the missing device to perform theft mitigation measures. A single control message or multiple control messages may be sent to prompt the performance of theft mitigation measures. In one or more embodiments, control messages may prompt individual theft mitigation measures. In some embodiments, the individual theft mitigation measures can be performed sequentially, which can be guided by an escalation of mitigation measures being performed, in part based on the distance away of the second device and/or the elapsed time since the second device has been detected as stolen or missing. In some embodiments, performing the theft mitigation measures can involve sending one control message for each mitigation measure to be completed at/by the second device. Accordingly, a set of more than one mitigation measures can be prompted by a single control message. Receipt of the control message(s)/signal(s) may prompt the missing device to autonomously perform a series of mitigation measures.

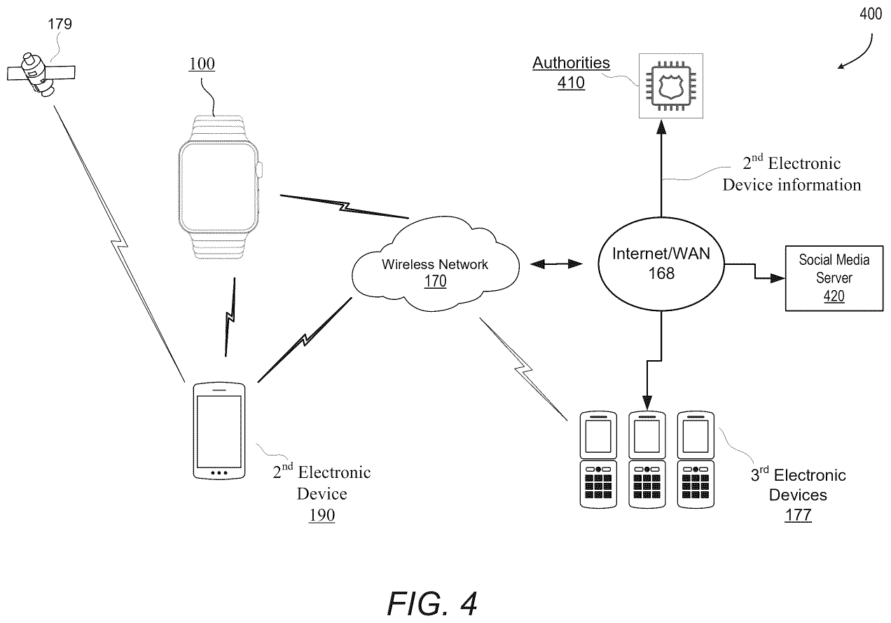

Mitigation measures that are triggered by the control messages may include locking the missing electronic device (e.g., the phone or the wearable device), emitting an alarm tone at the missing device, generating and transmitting a notification to a law enforcement reporting system (410, FIG. 4) to report the potential theft of the missing device to authorities, and/or triggering the second electronic device to record and transmit its global positioning system (GPS) location, network location, and barometric data, etc., to at least one of the electronic device and cloud storage that is accessible to the second electronic device. In some embodiments, when the theft is of the second electronic device 190 as the missing/stolen device, the mitigation measures are triggered by electronic device 100 and include transmitting instructions via short-range wireless connection 188/189a-189b to second electronic device wireless 190. In other embodiments, when the theft is of the electronic device 100 as the missing/stolen device, the mitigation measures are triggered by second electronic device 190 and include transmitting instructions via short-range wireless connection 188/189a-189b to electronic device wireless 100. Additional mitigation measures may include at least one of: generating and automatically uploading information related to a potential theft of the missing device to previously designated social media accounts that are directly accessible via the missing device; and/or disabling the missing device access to said previously designated social media accounts that are directly accessible from the missing electronic device. The user may predetermine the particular mitigation measures to be implemented and the order in which the mitigation measures will be implemented.

FIG. 2 is an example component makeup of second electronic device 190 with specific components that enable the device to mitigate the theft of another electronic device, such as electronic device 100, according to one or more embodiments. Second electronic device 190 can, in some embodiments, be an implementation of electronic device 100, having similar components and/or functionality. For purposes of the disclosure, second electronic device 190 is assumed to be a user wearable device. Second electronic device 190 includes processor (or controller) 202, which is communicatively coupled to combined memory/storage device 204 (collectively referred to hereinafter as memory 204), display 206, input/output (I/O) and power port 208, physical input buttons/actuator 210 and sensors 214. Processor 202 is further communicatively coupled to WNCS 216 with attached antenna 217, wireless interface 218, and power source 212. Second electric device 190 includes display 206, which incorporates a tactile, touch screen interface (not shown) that can receive user tactile/touch input. The touch screen interface can present visual content including a selectable icon 207 that can be utilized to trigger theft mitigation features, as described herein for some embodiments. I/O and power port 208 may be configured to interface with any number of devices including, but not limited to USB enabled devices. Sensors 214 may include, but are not limited to an accelerometer, a gyroscope, an ambient light sensor, a thermometer, a barometer, a fingerprint sensor, and a proximity sensor. WNCS 216, antenna 217, and input button (actuator) 220 have functionality identical to that attributed to their counterparts (WNCS 142, antenna 148, and input buttons 192) in FIG. 1. As with device 100, in one or more embodiments, WNCS 216 with antenna(s) 217 and wireless interface(s) 218 collectively provide wireless communications subsystem of electronic device 190. Likewise, the functionality of network server 175 and cellular wireless communication network 170 is substantially similar to that described in FIG. 1.

Memory/storage device 204 may store a local copy of theft mitigation module (TMM) 152 (FIG. 1) for implementing the first and/or second device features of the disclosure, by configuring processor to control the abovementioned hardware elements of second electronic device 190. In one or more embodiments, TMM 152 includes program instructions that configure processor 202 to cause electronic device 190, while operating as the remaining device that detects the movement away of the missing device, to detect a trigger condition corresponding to the potential theft of a second electronic device (e.g., electronic device 100) connected via short range wireless connection directly (188) or through local wireless network (189a-189b). In one or more embodiments, trigger conditions can include or cause manual depression of input button/actuator 210, or a selectable icon 207 at the remaining device.

The present disclosure contemplates theft mitigation being initiated by either of electronic device 100 or second electronic device 190 in order to facilitate safeguarding or retrieval of either device in the event the other device is lost, misplaced, or stolen. FIGS. 3A-3B and 3C illustrate two alternate implementations in which the roles of each of electronic device 100 and second electronic device 190 are reversed, whereby second electronic device 190 (FIG. 1) provides the features of remaining first electronic device in FIG. 3A-3B, then operates as the second electronic device that is stolen or missing in FIG. 3C. Inversely, electronic device 100 (FIG. 1) operates as the second electronic device that is stolen or missing in FIG. 3A-3B, then provides the features of remaining first electronic device in FIG. 3C.

FIGS. 3A-3B and 3C depict three schematic views illustrating an environment in which two portable electronic devices work in concert to mitigate the theft of one of the devices, according to some embodiments. FIG. 3B depicts a view substantially similar to that presented in FIG. 3A, but with a greater separation distance between the two devices and a different communication path for control signals sent between the two devices. In one or more embodiments, the two electronic devices have compositions as described in FIGS. 1 & 2 and are connected directly through a short-range wireless connection. According to one aspect, while each device is connected to the other via a short-range local wireless connection, such as BT, a normal separation range between the two devices is established and maintained/stored in local storage of each device as a first threshold distance (range) 320. First threshold distance (range) 320 can represent the distance that one or more of the device manufacturer, TMM code, the AI, or the device user (302) expects the two devices to be separated from each other during normal operation. For example, the first device (e.g., mobile phone) can be on a table or in a gym bag that is at most 30 yards/meters away from the second device (e.g., smart watch). First threshold distance 320 then represents a safe range of separation between the two devices in which the TMM features are not autonomously/dynamically triggered. Additionally, a second threshold distance (range) 330 can also be established based on a type of short-range wireless connection that is configured between the two devices. For example, with a Bluetooth low energy (BLE) connection, a maximum range of the BT signal for inter-device communication over BT can be 100 meters, after which the BT connection of the two devices will most probably be dropped. Accordingly, a second threshold distance 330 can be established that is less than the maximum communication range of the short-range wireless connection between the two devices. In FIGS. 3A-3B and 3C, both the first threshold distance 320 and the second threshold distance 330 are shown with diameters/distances measured from the first electronic device 308 and delineated by dashed circles 315, 325, respectively, surrounding first electronic device 308. The first and second threshold distances represent or are synonymous with diameters of the respective circles 315, 325. Each of first and second electronic devices 308 and 310 also store the secondary range limit, as the second threshold distance 330, which is the maximum separation distance within which communication can be attempted using the short-range connection.

It is anticipated that a person who steals (or takes without user permission) the second electronic device 310 would attempt to leave the location of user 302 and by extension first electronic device 308 with the stolen/misappropriated second electronic device 310. In the event that the second electronic device 308 is not moved out of the range of communication from first electronic device 308, recovery of second electronic device 310 can be completed by communicatively connecting to second electronic device 310 and triggering the theft mitigation measures from the first electronic device 308.

According to one aspect of the present disclosure, a separation distance between the two devices is periodically/continually measured, for instance, by using proximity sensors (148, 214) located within one or both devices. In the example of FIGS. 3A-3B, the first electronic device 308 is depicted as a user wearable device or smart watch (190, FIGS. 1 and 2) and the second electronic device 310 is depicted as a mobile phone (100, FIGS. 1 and 2). First electronic device 308 is in a fixed location proximate to or on user 302. According to some embodiments, the theft mitigation processes can be automatically triggered at the first electronic device 308 whenever the second electronic device 310 moves to a distance that is beyond the first threshold distance 320 from first electronic device 308. It is understood and/or appreciated that it is the movement of the second electronic device 310 away from a centralized location of first electronic device 308, that is not moving, that would trigger the theft mitigation features from the first electronic device 308 and vice versa. That is, if the second electronic device 310 remains in a current location (i.e., is not moving away from its established location), while the user moves away with the first electronic device 308 beyond the first threshold distance 320, then the respective roles of the devices switch to the embodiment shown in FIG. 3C. In this instance, the theft mitigation process causes a notification to be generated and surfaced on the device being used/worn by the user to indicate that unexpected separation from the other device is detected.

Returning to the example of FIGS. 3A-3B, in the event of a potential theft of the second electronic device 310 (i.e., the missing device), first electronic device 308 (i.e., the remaining device) transmits a control signal 305A via short-range wireless technology to the missing device 310, instructing the missing device 310 to complete at least a first theft mitigation measure. In some embodiments, control signal 305A is transmitted via short-range wireless technology while the distance between the devices does not exceed the second threshold distance 330. Otherwise, a second/different control signal 307A-307B may be transmitted using wireless communication network 170. In some embodiments, each subsequent theft mitigation measure can be prompted by an additional control signal. In other embodiments, a single control signal is generated and transmitted to the missing device, and the single control signal then activates a plurality of theft mitigation measures. The specific theft mitigation measures that are activated or performed by the missing device can be based on a pre-configuration of the device theft mitigation response module to respond to a specific type of trigger that correlates or is associated with specific type(s) of response(s). Thus different types of control signals can be transmitted, each triggering different theft mitigation responses from the missing device. In particular, when the missing device is outside of a range of the short-range communication connection/link, the responses to a received control signal can be pre-programmed to be different from responses when the missing device is still within communication range of the short-range communication connection/link.

According to one or more aspects, theft mitigation can be carried out through sending one or multiple control messages to the missing device. In the event that a potential theft of the second device 310 is discovered or identified when the second device 310 is beyond the first threshold distance, which is still within the effective range of a short-range wireless connection to which both devices are connected, the remaining device 308 transmits a control signal to the missing device 310 over the short-range wireless communication connection instructing the missing device to complete at least a first theft mitigation measure. In one embodiment, each subsequent theft mitigation measure can be prompted by an additional control signal. Referring to FIG. 3B, in the event of a potential theft situation where the second device 310 moves to beyond the second threshold distance 330, which is a distance that exceeds the effective range of the short-range wireless connection, the remaining device 310 transmits control signal 307A to the missing device 310 via external communications link 172, instructing the missing device 310 to enter a theft mitigation mode and complete one or more theft mitigation measures.

When a potential theft occurs while the separation distance is still within the first or second threshold distance, at least one control message can be transmitted to the missing device for one or more mitigation actions to be performed. When the potential theft occurs with the missing device being moved beyond either threshold distance, a single control message can be transmitted from the remaining device prompting the missing device to autonomously implement a set or sequence of preset mitigation measures, regardless of the distance between the remaining device and the missing device.

Alternatively, in some embodiments, the missing device 310 may be programmed to enter theft mitigation mode automatically and autonomously/dynamically execute appropriate mitigation measures, without receiving control messages from the remaining device 308 once the missing device 310 senses that the missing device 310 is located outside of one or both threshold distances.

FIG. 3B provides a similar implementation as FIG. 3A. The figures only differ in the distance between the devices and the pathway over which control signals are transmitted from the remaining device to the missing device. In FIG. 3B, the missing device is located beyond the 2^{nd} threshold distance. This is beyond the range of the short-range wireless connection. Thus, control signals must be sent over cellular wireless communication network 170. In some embodiments, the control signal(s) can be different from the control signals transmitted over the short-range wireless connection, triggering different set of responses, and/or the response of the missing device to receipt of the control signal over the cellular network 170 can be pre-programmed to be different. Beyond these differences in the propagation path of the control signal(s), type of control signal, and/or pre-programmed responses to receipt of control signals via the different propagation paths, the description of the other features of FIG. 3B is similar to that of FIG. 3A and is therefore not re-presented herein for brevity.

FIG. 3C provides a similar implementation as FIG. 3A, with only the illustrated electronic devices that perform the roles of the first electronic device (the remaining device) and the second electronic device (the missing device) switched. The description of FIG. 3C thus mirrors that of FIG. 3A for the most part and is therefore not re-presented herein for brevity. It is appreciated that the supported functionality of each of the two devices can be different and that those differences can alter or affect which features can be provided by the first electronic device and by the second electronic device. Those skilled in the art would appreciate such differences.

As shown above, a missing device 310 may enter theft mitigation mode, with or without prompting from the remaining device 308, as part of the theft mitigation process. In theft mitigation mode, any activity performed by the missing device 310 (e.g. phone calls, text messages, theft mitigation measures, etc.) is accompanied by a notification transmitted from the missing device 310 to at least the remaining device 308 or third electronic devices 177 over a range-appropriate connection. No indication (e.g. audio, visual, or haptic activity) that could alert a potential thief that such a notification is being sent accompanies such notifications. The notifications facilitate monitoring the activity and the physical location of the missing device 310. Though in the above description, 310 is the missing device and 308 is the remaining device, as discussed in the description of FIG. 3C, the roles of the devices may be reversed.

FIG. 4 depicts a schematic view of a communication environment having a plurality of devices that are configured to mitigate the theft of a communicatively-connected electronic device, according to one or more embodiments. In a preferred embodiment, two electronic devices having compositions as described in FIGS. 1 & 2 are connected via short range wireless connection 188 directly or through a local WiFi network router 166.

In one or more embodiments, TMM 152 includes program instructions that are processed by processor 102, which is configured to cause electronic device 100 to detect a trigger condition corresponding to the potential theft of one of two electronic devices connected via a short-range wireless connection. Trigger conditions can include determining (e.g. via proximity sensors 148) the distance between the two electronic devices 100, 190 and assessing that the distance exceeds one or more threshold distances. An example first threshold distance is a distance that is close enough to allow for a continued direct short range wireless connection between the two devices but is beyond a point designated by the user as the furthest distance the user would be from the potentially stolen device under normal conditions. An example second threshold distance is a distance beyond which direct short range wireless communication between the two devices is not possible. Assuming the theft is of connected second electronic device 190, with electronic device 100 being the remaining device, upon detecting that the first threshold has been exceeded, processor 102 is configured to cause the remaining electronic device (i.e., first electronic device 100) to a send control message directly over short range wireless connection 188 to the missing electronic device (i.e., second electronic device 190), prompting the missing device to perform theft mitigation measures. Alternatively, upon detecting that the second threshold has been exceeded, processor 102 is configured to cause the remaining electronic device to a send control message via the wireless communication network 170 to the missing electronic device, prompting the missing device to perform theft mitigation measures. In one embodiment, when the two devices are unable to communicate via both short-range connection and the wireless communication network 170, processor 102 can be configured to cause the remaining electronic device to send a control message, via an external communication link (e.g. a wide area network (WAN) 168), to the missing electronic device, prompting the missing device to perform theft mitigation measures. A single control message or multiple control message may be sent to prompt the performance of theft mitigation measures. Control message may prompt individual theft mitigation measures. In some embodiments, the individual theft mitigation measures can be performed sequentially, and can be guided by an escalation of mitigation measures being performed, in part based on the distance away of the second device and/or the elapsed time since the second device has been detected as stolen or missing. In some embodiments, performing the theft mitigation measures can involve sending one control message for each mitigation measure to be completed at/by the second device. Control signals may prompt the missing device to autonomously perform a series of mitigation measures. A set of more than one mitigation measures can be prompted by a single control message.

Mitigation measures that are triggered by the control messages may include locking the missing electronic device (e.g., the phone or the wearable device), emitting an alarm tone at the missing device, generating and transmitting a notification to a law enforcement reporting system (410, FIG. 4) to report the potential theft of the missing device to authorities, and/or triggering the second electronic device to record and transmit its global positioning system (GPS) location, network location, and barometric data, etc., to at least one of the electronic device and cloud storage that is accessible to the second electronic device. In some embodiments, when the theft is of the second electronic device 190 as the missing/stolen device, the mitigation measures are triggered by electronic device 100 and include transmitting instructions via short-range wireless connection 188/189a-189b to second electronic device wireless 190. In other embodiments, when the theft is of the electronic device 100 as the missing/stolen device, the mitigation measures are triggered by second electronic device 190 and include transmitting instructions via short-range wireless connection 188/189a-189b to electronic device wireless 100. Additional mitigation measures may include at least one of: generating and automatically uploading information related to a potential theft of the missing device to previously designated social media accounts that are directly accessible via the missing device and/or disabling the missing device access to said previously designated social media accounts that are directly accessible via the missing electronic device.

The theft mitigation measures pursued may escalate over time to facilitate efficient handling. For instance, one embodiment may provide that the effective range of the short range wireless connection 188 dictates that the missing device is within earshot of the user of the remaining device. Accordingly, when a control message is sent directly from the remaining device to the missing device via short range wireless connection 188, an alarm tone is emitted from the missing device and heard by the user of the remaining device. No further action may need to be taken. The user may simply cancel theft mitigation on the display 206 of the missing device upon following the alarm tone to the missing device's location. However, as the distance between the remaining and missing devices increases, it may be necessary to notify persons not within earshot of the missing device. Thus, as shown herein, 3^{rd} electronic devices 177 (e.g., concerned acquaintances of the owner of the missing device) or even the authorities 210 (e.g. the police) may need to be contacted over the wireless communication network 170. Appropriate mitigation measures may include sharing the GPS location, cellular network location (collected using data from the cellular network and a Wi-Fi connection), barometric data, locally captured audio and visual data of a potential theft suspect and his surroundings, and other data relevant to retrieving a missing device with authorities 210, 3^{rd} electronic devices 177. Appropriate information may also be shared with social media accounts associated with the missing device 420 over, for example, the internet 168.

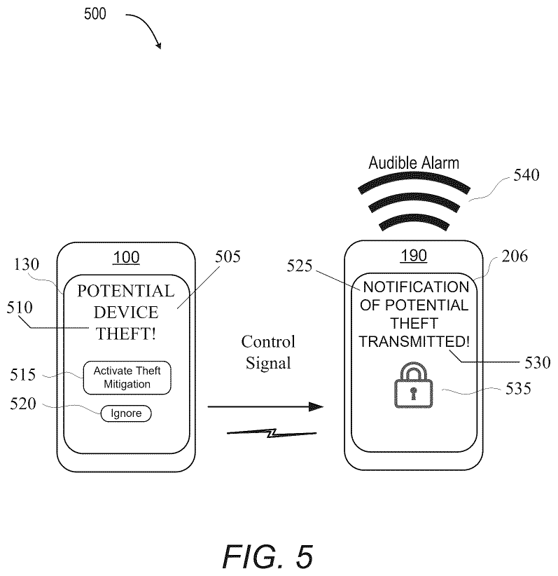

FIG. 5 depicts two user interfaces of the example portable electronic devices shown in FIG. 4. In one or more embodiments, the user interfaces 505, 525 shown in FIG. 5 may be rendered on displays 130 and 206 of electronic device 100 of FIG. 1 and second electronic device 190 of FIG. 2. Upon the detection of a triggering event as described in relation to FIG. 1 and FIG. 2, processor 102 at device 100 is configured to cause the electronic device 100 to display rendered content and prompt the second device 190 to display rendered content. The rendered content of user interface 505 presented on display 130 includes theft notification 510, selectable theft mitigation activation option button 515 and selectable ignore button 520. The rendered content of user interface 525 presented on display 206 includes theft reported notification 530 and a screen lock icon 535. Theft mitigation activation option button 515, if depressed, prompts device 100 to send at least one control message to second device 190 prompting the implementation of mitigation measures as described in relation to FIGS. 1-4. Mitigation measures may include sounding an audible alarm 540 so that the alarm can be audibly heard by others in vicinity of the stolen/missing device (190). Ignore button 520, if depressed, stops the mitigation process. Depressing the ignore button 520 unlocks missing device 190, clearing the screen lock icon 535 from display 206, and clears the “potential theft reported” notification 530. Following the depression of the ignore button 520, both devices return to their normal state of operation. Alternatively, when the user of the two devices manually activates theft mitigation by depressing an actuator 192 or selectable icon 194a, 194b (e.g. when the user knows or suspects that the second electronic device is lost, stolen, or misplaced) content rendering and mitigation are performed as described above.

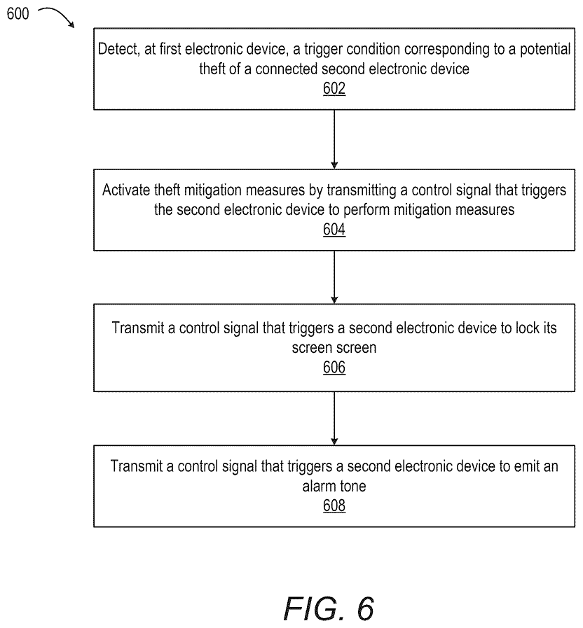

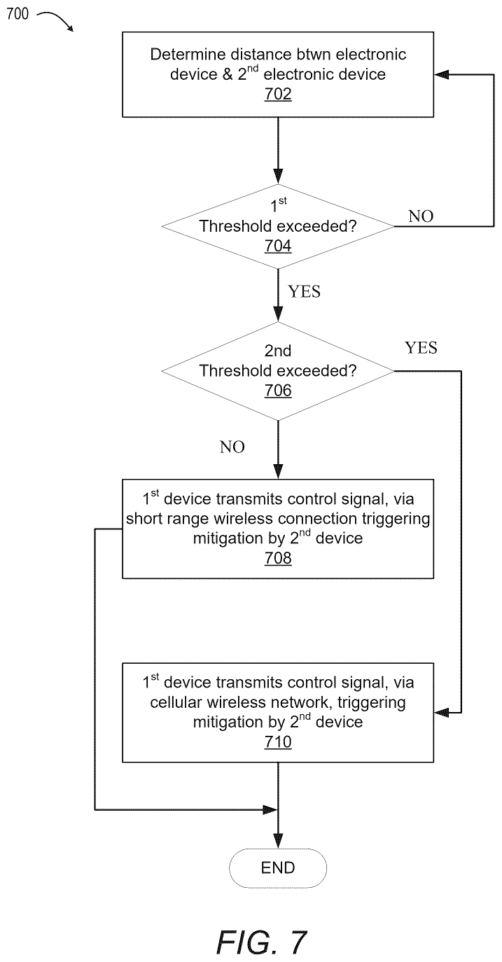

Referring now to the flowcharts presented by FIG. 6 and FIG. 7, the descriptions of the methods in FIG. 6 and FIG. 7 are provided with general reference to the specific components and features illustrated within the preceding FIGS. 1-5. Specific components referenced in the methods of FIG. 6 and FIG. 7 may be identical or similar to components of the same name used in describing preceding FIGS. 1-5. In one or more embodiments, processor 102 (FIG. 1) configures electronic device 100 (FIG. 1) to provide the described functionality of the methods of FIG. 6 and FIG. 7 by executing program code for one or more modules or applications provided within system memory 120 of electronic device 100, including TMM 152 (FIG. 1). Alternatively, in some embodiments, processor 202 (FIG. 2) configures second electronic device 190 (FIG. 1) to provide the described functionality of the methods of FIG. 6 and FIG. 7 by executing program code for one or more modules or applications provided within system memory 204 of second electronic device 190, including TMM 205 (FIG. 2).

FIG. 6 depicts a flowchart illustrating a method for mitigating the theft of an electronic device, according to one or more embodiments. The method 600 starts at block 602, where an electronic device, communicatively connected via a wireless connection to a second electronic device, detects a trigger condition corresponding to a potential theft of the connected second electronic device. The method 600 continues to block 604, where in response to one or more preset triggering criteria being met, the processor activates theft mitigation measures. Theft mitigation measures are activated by sending control signals from the first electronic device (the remaining device) to the second electronic device, which is the missing device. The method 600 continues to block 606, at which, as a mitigation measure the electronic device transmits at least one control signal that triggers the second electronic device to lock a screen of the second device. The method continues to block 608 at which, as a mitigation measure, the electronic device transmits at least one control signal that triggers the second electronic device to emit an alarm tone. Other mitigation measures are possible beyond those disclosed in the embodiments.

FIG. 7 depicts a flowchart illustrating a method for mitigating the theft of a wirelessly-connected electronic device, according to one or more embodiments. The method starts at block 702, where the distance between two electronic devices linked via a short-range wireless connection is measured. The method continues at block 704, where the distance measured at block 702 is compared to a first pre-established threshold distance representing an expected operating range. If, at block 704, it is determined that the distance between the first device and the second device does exceed the first pre-established threshold distance, the method proceeds to block 706, where it is determined whether the distance between the first device and the second device exceeds a second pre-established threshold representing a limit of an effective range of the direct short-range wireless connection between the two electronic devices. It at block 706, it is determined that the distance between the first device and the second device does exceed the second pre-established threshold distance, the method continues to block 710 where the first device generates and transmits to the second device, via a cellular wireless network to which the first electronic device and the second electronic device are communicatively connected, a control signal that prompts the second electronic device to implement preprogrammed theft mitigation measures and the method ends. If at block 706, it is determined that the distance between the first device and the second device does not exceed the second pre-established threshold distance, the method continues to block 708, where the first device generates and transmits to the second device, via a direct short-range wireless connection, a control signal that prompts the second electronic device to implement preprogrammed theft mitigation measures and the device ends.

The examples presented herein describe devices and methods whereby users of portable electronic devices that are communicatively connected through short-range wireless connections may better protect and retain said devices. The contemplated embodiments allow for a user to be notified that a portable electronic device is at or approaching a location outside of a normal daily operating area. Additionally, at this range, the missing device is prompted over the direct short-range wireless connection shared with the remaining device to perform mitigation measures aimed at preventing theft of the device or aiding in the return of the device. The contemplated notification system can also be implemented when a connected portable electronic device exceeds the direct short-range wireless connection between the two devices, where the remaining device prompts the missing device over a wireless mobile network to which both devices are connected to initiate actions to mitigate the potential loss or theft of the missing device. In the aggregate, the measures disclosed herein ensure that loss or theft of a connected portable electronic device is preempted, or failing that ensure that the device is quickly located and returned.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display embedded in a user accessible surface of the electronic device;
a communications subsystem comprising an interface that enables the electronic device to communicatively connect via a wireless connection to a second electronic device;
a memory having stored thereon a theft mitigation module (TMM) for controlling a plurality of hardware elements of the electronic device; and
at least one processor communicatively coupled to the display, the communications subsystem, and the memory, the at least one processor executing program code of the theft mitigation module, and configured to cause the electronic device to:
in response to one or more preset triggering criteria being met, activate theft mitigation measures comprising transmitting at least one control signal that triggers the second electronic device to perform at least one of:
locking a second device screen; and
emitting an alarm tone.

2. The electronic device of claim 1, wherein the wireless connection is achieved using at least one short-range communications protocol from a group comprising: Bluetooth®, Wi-Fi, or near field communication.

3. The electronic device of claim 1, wherein: the one or more preset triggering criteria are associated with a potential theft of the second device; and to perform the mitigation measures, the at least one processor is further configured to cause the electronic device to generate and transmit a notification to a law enforcement reporting system to report the potential theft of the second electronic device to authorities.

4. The electronic device of claim 1, wherein the preset triggering criteria may comprise manual depression of at least one of:
an actuator of the electronic device; or
a selectable icon within a graphical user interface presented on the screen of the display.

5. The electronic device of claim 1, wherein to perform the mitigation measures the at least one processor is further configured to cause the electronic device to:
transmit instructions via the wireless connection to trigger the second electronic device to record and transmit its global positioning system (GPS) location to at least one of the electronic device and cloud storage accessible to the second electronic device.

6. The electronic device of claim 5, wherein the at least one processor is further configured to cause the electronic device to perform at least one of:
generate and automatically upload information related to a potential theft of the second electronic device to previously designated social media accounts directly accessible via the second electronic device; and
disable second electronic device access to said previously designated social media accounts that are directly accessible via the second electronic device.

7. The electronic device of claim 1, wherein the at least one processor is further configured to cause the electronic device to: determine whether a distance between the electronic device and the second electronic device has exceeded a first pre-established threshold distance representing an expected operating range and a second pre-established threshold representing a limit of an effective range of the wireless connection directly between the two electronic devices.

8. The electronic device of claim 7, wherein the at least one processor is further configured to cause the electronic device to: in response to the distance between the electronic device and the second electronic device exceeding the first pre-established threshold but not the second pre-established threshold, generate and transmit to the second device via a direct short range wireless connection, a control signal that prompts the second electronic device to implement preprogrammed theft mitigation measures.

9. The electronic device of claim 7, wherein the at least one processor is further configured to cause the electronic device to: in response to the distance between the electronic device and the second electronic device exceeding the second pre-established threshold, generate and transmit to the second electronic device, via a cellular wireless network to which the first electronic device and the second electronic device are communicatively connected, a control signal that prompts the second electronic device to implement preprogrammed theft mitigation measures.

10. A method comprising:
detecting, by a processor of an electronic device that is communicatively connected via a short range wireless connection to a second electronic device, a trigger condition corresponding to a potential theft of the connected second electronic device;
in response to detecting the trigger condition, activating theft mitigation measures, comprising transmitting at least one control signal that triggers the second electronic device to perform at least one of:
locking a screen of the second device; and
emitting an alarm tone.

11. The method of claim 10, further comprising:
generating a notification indicating a potential theft of the second device; and
transmitting said notification to a law enforcement reporting system to report the potential theft of the second electronic device to authorities.

12. The method of claim 10, wherein:
the at least one control signal further triggers the second electronic device to activate input devices of the second electronic device to capture one or both of audio and visual data of device surroundings, including persons in possession of or in proximity to the second electronic device; and
the method further comprises transmitting said data to authorities.

13. The method of claim 10, further comprising performing at least one of:
generating and automatically uploading information related to a potential theft of the second electronic device to previously designated social media accounts directly accessible via the second electronic device; and
disabling second electronic device access to said previously designated social media accounts that are directly accessible via the second electronic device, the disabling being triggered by the at least one control signal transmitted to the second electronic device.

14. The method of claim 10, further comprising:
triggering, by the at least one control signal, the second electronic device to record and report its global positioning system (GPS) location, wherein the second electronic device is remotely configured to transmit said location to at least one of the electronic device, cloud storage accessible to the second electronic device; and one or more predetermined electronic devices registered to acquaintances of a user of the second device.

15. The method of claim 10, further comprising:
detecting that a distance between the electronic device and the second electronic device has exceeded a pre-established threshold distance while still within an effective range of the wireless connection; and
in response to the distance exceeding the pre-established threshold distance, transmitting, the at least one control signal that prompts the second electronic device to autonomously implement a series of preprogrammed theft mitigation measures.

16. The method of claim 10, further comprising:
determining whether a distance between the electronic device and the second electronic device has exceeded a first pre-established threshold distance representing an expected operating range and a second pre-established threshold representing a limit of an effective range of the wireless connection directly between the two electronic devices;
in response to the distance between the electronic device and the second electronic device exceeding the first pre-established threshold but not the second pre-established threshold, generating and transmitting to the second device via a direct short-range wireless connection, a control signal that prompts the second electronic device to implement preprogrammed theft mitigation measures; and
in response to the distance between the electronic device and the second electronic device exceeding the second pre-established threshold, generating and transmitting to the second electronic device, via a cellular wireless network to which the first electronic device and the second electronic device are communicatively connected, a control signal that prompts the second electronic device to implement preprogrammed theft mitigation measures.

17. The method of claim 10, wherein activating theft mitigation measures comprises:
generating and outputting a notification of a potential theft event on the display of the first electronic device; and
receiving a user selection of a selectable icon within a graphical user interface presented on the display, the selection of the selectable icon activating device theft notification and response features of the first and second electronic devices.

18. A computer program product comprising a non-transitory computer readable medium having program instructions that when executed by a processor of an electronic device that comprises an interface that enables the electronic device to communicatively connect via a wireless connection to a second electronic device, configure the electronic device to perform functions comprising:
detecting, by a processor of an electronic device that is communicatively connected via a short range wireless connection to a second electronic device, a trigger condition corresponding to a potential theft of the connected second electronic device;
in response to detecting the trigger condition, activating theft mitigation measures, comprising transmitting at least one control signal that triggers the second electronic device to perform at least one of:
locking a screen of the second device; and
emitting an alarm tone.

19. The computer program product of claim 18, further comprising program instructions for:
generating a notification indicating a potential theft of the second device; and
transmitting said notification to a law enforcement reporting system to report the potential theft of the second electronic device to authorities.

20. The computer program product of claim 18, further comprising program instructions for:
triggering, by the at least one control signal, the second electronic device to record and report its global positioning system (GPS) location, wherein the second electronic device is remotely configured to transmit said location to one or more predetermined electronic devices registered to acquaintances of a user of the second device.
